(19) United States
(12) Patent Application Publication
(10) Pub. No.: US 2001/0029627 A1
(43) Pub. Date: Oct. 18, 2001

(54) Carriage

(75) Inventor: Philip Von Schroeter, Gloucestershire (GB)

Correspondence Address: YOUNG & THOMPSON, 745 SOUTH 23RD STREET 2ND FLOOR, ARLINGTON, VA, 22202

(73) Assignee: Arjo Limited

(21) Appl. No.: 09/817,059

(22) Filed: Mar. 27, 2001

(30) Foreign Application Priority Data
Apr. 12, 2000 (GB) 0008833.6

(51) Int. Cl. A61G 7/10

(52) U.S. Cl. 5/86.1

(57) ABSTRACT

A carriage, such as an invalid hoist or shopping trolley, is mounted on castors. Each castor is swivellable about a first axis. At least one of the castors is supported by a support element which is angularly displaceable about a second axis parallel to the intended direction of fore and aft movement of the carriage. The first axis is perpendicular or substantially perpendicular to the second axis. Means are provided for angularly displacing the support element about the second axis to encourage the castor supported thereby to swivel one way or the other according to the direction in which the support element is angularly displaced and to steer the carriage when the latter is propelled along the ground.

### INTRODUCTION

This invention relates to a carriage, particularly a steerable carriage such as an invalid hoist or shopping trolley.

### SUMMARY OF THE INVENTION

According to the present invention there is provided a carriage mounted on castors, each of which is swivellable about a first axis, at least one of the castors being supported by a support element which is angularly displaceable about a second axis parallel to the intended direction of fore and aft movement of the carriage, said first axis being perpendicular or substantially perpendicular to said second axis, and means being provided for angularly displacing said support element about said second axis to encourage the castor supported thereby to swivel one way or the other according to the direction in which the support element is angularly displaced and to steer the carriage when the latter is propelled along the ground.

The invention will now be more particularly described, by way of example, with reference to the accompanying drawings.

### BRIEF DESCRIPTION OF THE DRAWINGS

FIG. 1 is a perspective view of a carriage according to the present invention, in the form of an invalid hoist,

FIG. 2 is an end view of one of the chassis members of the hoist shown in FIG. 1, in a first condition,

FIG. 3 is a view similar to FIG. 2 with the chassis member in a second condition,

FIG. 4 is a view similar to FIG. 2 with the chassis member in a third condition,

FIG. 5 is a view similar to FIG. 2 with the chassis member in a fourth condition,

FIG. 6 is a fragmentary perspective view showing the chassis member and lower part of the mast with the chassis member in said first or third condition, and

FIG. 7 is a view similar to FIG. 6 but with the chassis member in said second or fourth condition.

### DESCRIPTION OF THE PREFERRED EMBODIMENTS

Referring now to the drawings, the carriage shown therein is in the form of an invalid hoist comprising a first telescopically extendible/retractable mast 10 upstanding from a first elongate chassis member 11 and a second telescopically extendible/retractable mast 12 upstanding from a second elongate chassis member 13. Each mast has an upper part 14 and a lower part 15.

A lifting arm 16 is supported by and extends between the upper parts 14 of the first and second masts 10 and 12, respectively. The lifting arm 16 comprises two parts 17 and 18 pivotable relative to one another in a horizontal plane. The part 17 is supported by the upper part 14 of the first mast 10 and the part 18 is supported by the upper part of the second mast 12. The lifting arm 16 is the sole means connecting the first mast 10 and the chassis member 11 to the second mast 12 and the chassis member 13.

Each part 17 and 18 of the lifting arm comprises a parallelogram linkage 19 to maintain the chassis members 11 and 12 in parallel spaced relationship as the two parts 17 and 18 of the arm 16 pivot relative to one another and a carriage 20 which is mounted on the upper part 14 of the mast.

The upper mast parts 14 telescope over the lower mast parts 15. The carriages 20 can be raised or lowered relative to the upper mast parts 14 in addition to being raised and lowered by relative movement of the two mast parts 14, 15 to increase the overall lifting range of the lifting device. A power operated actuator (not shown) is provided in each mast for extending and retracting the two masts, and for raising and lowering the two carriages, in synchronism with one another.

An actuator (not shown) is accommodated in housing 21 for angularly displacing the two parts 17 and 18 of the lifting arm relative to one another.

A sling hanger 22 for supporting a full body sling is suspended from the lifting arm 16 by a sling hanger support 23. The sling hanger 22 is pivotable relative to the sling hanger support 23 about a horizontal axis.

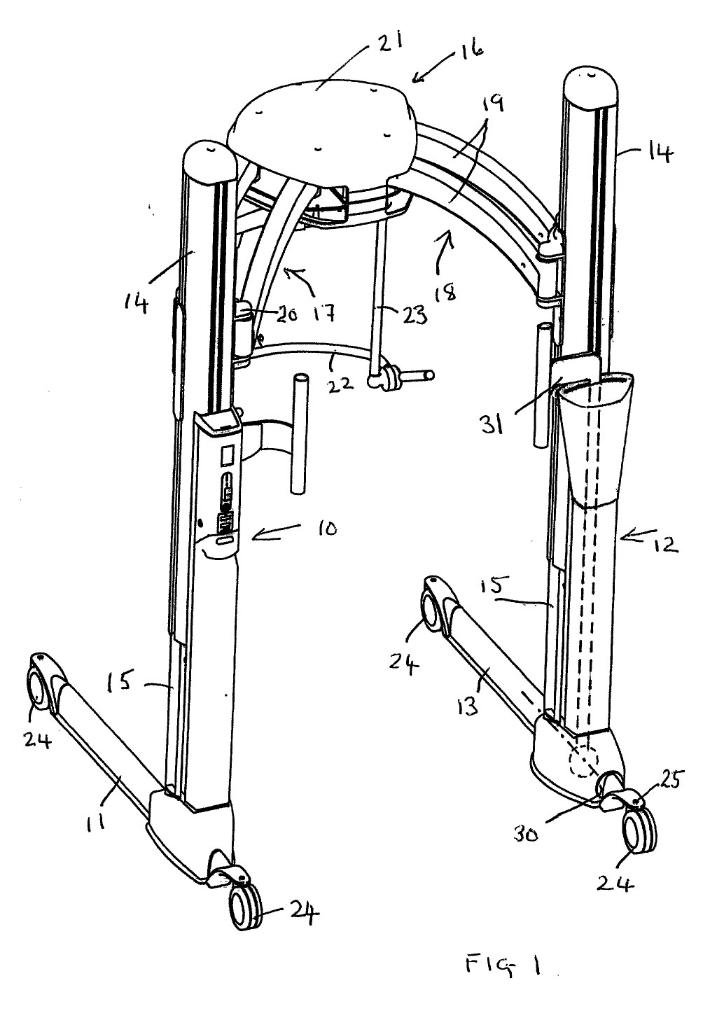

Each chassis has two castors 24 swivellable about an in use vertical axis 25. The castors 24 are shown in FIG. 1 in positions which result in the chassis moving in a straight line if propelled manually along the ground in for or aft direction.

The chassis member 13 is supported in a bearing 30 at the base of the lower part 15 of the mast 12 for angular displacement about an in use horizontal axis 26 extending in the direction of the longitudinal extent of the chassis member 13.

The chassis member 13 is angularly displaceable in the bearing 30 by a lever 31. Alternatively, it could be pivotable by a motor and gearbox unit (not shown) housed in the base of the lower part 15 of the mast 12.

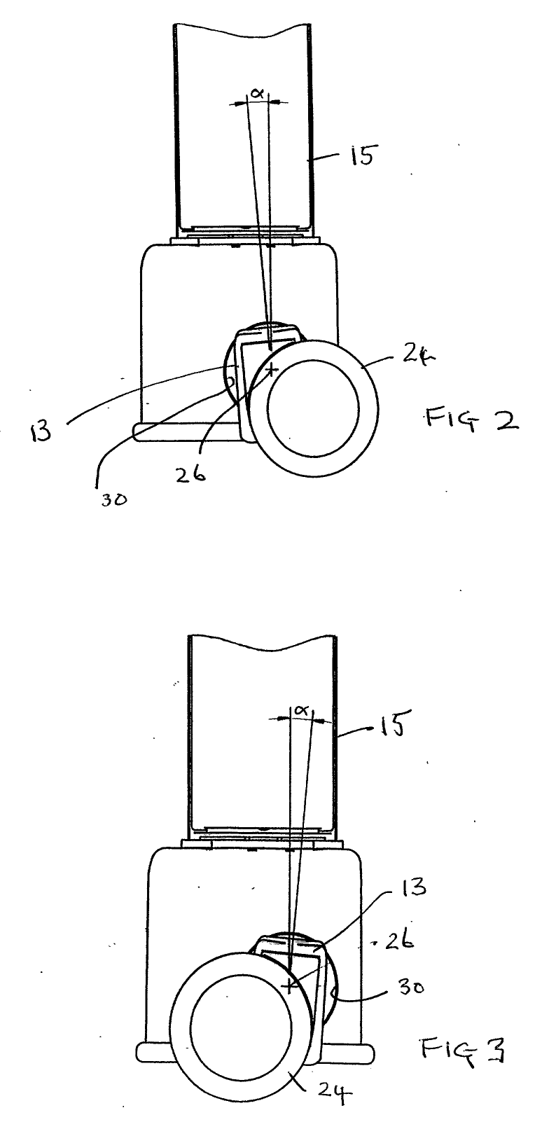

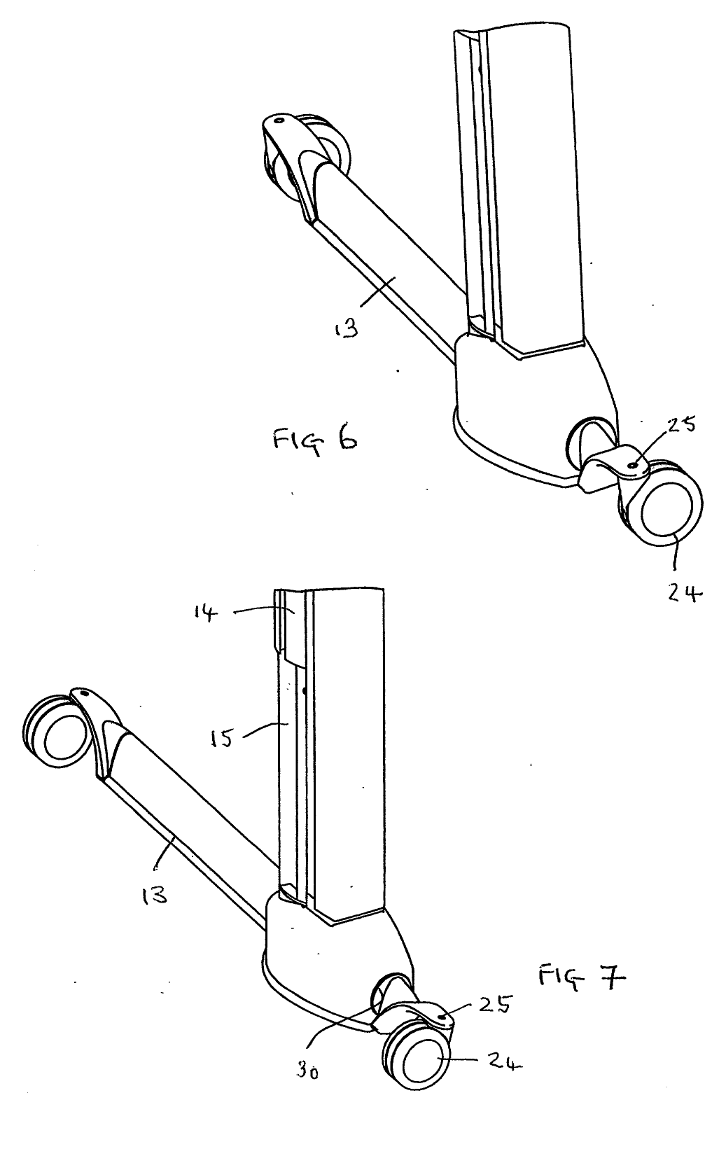

The chassis member 13 is pivoted through an angle α, typically in the region of 5°, in an anti-clockwise direction, as viewed in FIGS. 2 to 6 to encourage the castors 24 supported by the chassis member 13 to swivel to the position as shown in FIG. 2 in order to steer the chassis to the left when the latter is propelled along the ground. The chassis member 13 is angularly displaced through a similar angle α in a clockwise direction, as viewed in FIGS. 3 and 7, in order to encourage the castors to swivel to the position as shown in FIGS. 3 and 7 in order to steer the chassis to the right when the latter is propelled along the ground.

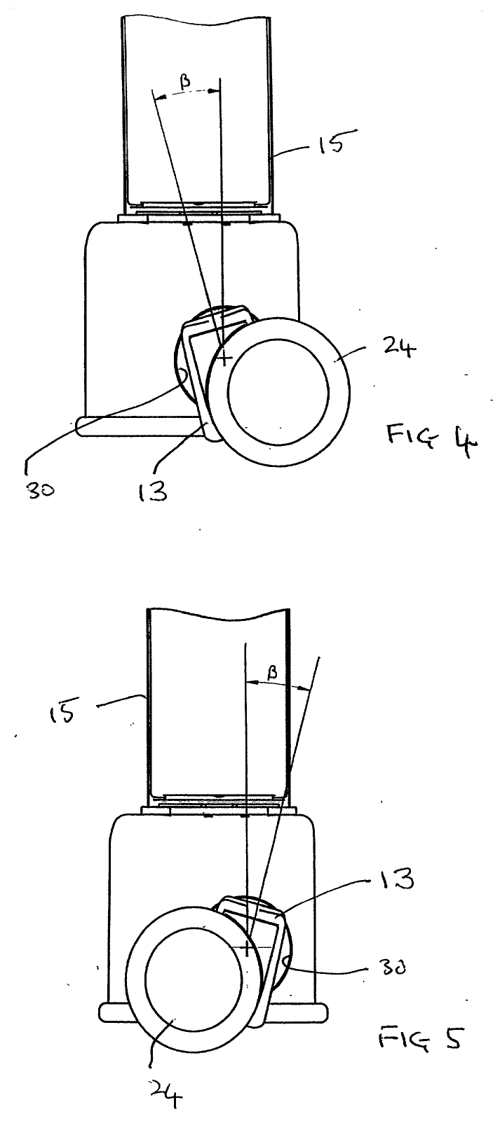

The chassis member 13 can be angularly displaced through a larger angle β, typically in the region of 15°, as shown in FIGS. 4 and 5 to facilitate the movement of the chassis member 13 towards or away from the chassis member 11 when the two parts of the lifting arm are pivoted relative to one another to reduce or increase the width of the chassis.

Although, as described above, a chassis member and two castors are pivotable about the axis 26, it is conceivable that a single castor and support element therefor are pivotable about an axis parallel to the intended direction of fore and aft movement of the carriage to encourage that castor to steer the carriage when the latter is propelled along the ground.

The carriage as described above has been described in the form of a particular type of lifting hoist. The carriage could be in the form of other types of lifting hoist and in particular in the form of lifting hoists in which the two chassis members are connected together by a fixed or telescopically extendible cross member at the base of the hoist. The carriage could take other forms and, in particular, could be in the form of a shopping trolley.

What is claimed is:

1. A carriage mounted on castors, each of which is swivellable about a first axis, at least one of the castors being supported by a support element which is angularly displaceable about a second axis parallel to the intended direction of fore and aft movement of the carriage, said first axis being perpendicular or substantially perpendicular to said second axis, and means being provided for angularly displacing said support element about said second axis to encourage the castor supported thereby to swivel one way or the other according to the direction in which the support element is angularly displaced and to steer the carriage when the latter is propelled along the ground.

2. A chassis as claimed in claim 1, wherein the displacing means comprises a manually operable lever.

3. A carriage as claimed in claim 1, wherein the displacing means comprises a power driven actuator.

4. A carriage as claimed in claim 1, wherein the carriage is in the form of a chassis comprising a pair of parallel spaced apart elongate chassis members connected together by at least one cross member, each chassis member supporting two castors swivellable about respective first axes, one of the chassis members forming the support element for two of said castors and being angularly displaceable about said second axis which also extends in the direction of the longitudinal extent of said one chassis member.

5. A carriage as claimed in claim 4, wherein the chassis member is angularly displaceable through a first angle to steer the chassis and through a second larger angle to facilitate movement of the one chassis member towards or away from the other chassis member.

6. A carriage as claimed in claim 4, wherein said one chassis member is mounted for said angular displacement in a bearing supported directly or indirectly by the said at least one cross member.

7. A carriage as claimed in claim 1, in the form of an invalid hoist.

8. An invalid hoist as claimed in claim 7, further comprising a first telescopically extendible/retractable mast upstanding from one fo the chassis members, a second telescopically extendible/retractable mast upstanding from the other chassis member, each mast having an upper part and a lower part, the cross member being in the form of a lifting arm supported by and extending between the first and second masts, and power operated means for extending and retracting the first and second masts in synchronism with one another.

9. An invalid hoist as claimed in claim 8, wherein the lifting arm maintains the two chassis members in spaced apart parallel or substantially parallel relationship.

10. An invalid hoist as claimed in claim 8, wherein the lifting arm is the sole means connecting the first mast and chassis member to the second mast and chassis member.

11. An invalid hoist as claimed in claim 8, wherein the lifting arm can be raised or lowered relative to the masts.

12. An invalid hoist as claimed in claim 8, wherein the lifting arm comprises two parts pivotable relative to one another about a vertical or substantially vertical axis, one part being supported by the first mast and the other part being supported by the second mast.

13. An invalid lifting device as claimed in claim 12, wherein each part of the lifting arm comprises a parallelogram linkage to maintain the chassis members in parallel spaced relationship as the two parts of the arm pivot relative to one another.

14. A carriage as claimed in claim 1, in the form of a shopping trolley.
